(19) United States
(12) Patent Application Publication
(10) Pub. No.: US 2012/0325548 A1
(43) Pub. Date: Dec. 27, 2012

(54) WATERTIGHT SEAL ASSEMBLY

(76) Inventors: Timothy L. Martinson, Boca Raton, FL (US); Bruce A. Hyndman, Delray Beach, FL (US)

(21) Appl. No.: 13/167,306

(22) Filed: Jun. 23, 2011

(51) Int. Cl. H02G 3/18

(52) U.S. Cl. 174/652

(57) ABSTRACT

A watertight seal assembly for an electrical connection prevents moisture intrusion with a submerged device and features a wire plug having an opening sized for watertight receipt of a wire jacket and apertures sized to feed wire leads into the housing of the electric device. The wire plug is sized to form a watertight seal within a frusto-conical cavity located on the housing of the submerged electric device. A wire cap having a hole for sealed passage of the wire jacket fits over the wire plug and locks together with an attachment hub on the housing of the submerged electric device, producing a watertight seal. The inner surface of the hole in the wire cap opening includes nubs that bite into the wire jacket as the wire cap is twisted, thereby creating a watertight seal between the cap and wire jacket and providing an additional barrier for avoiding moisture intrusion.

### BACKGROUND OF THE INVENTION

1. Field of the Invention

The present invention relates to underwater electrical wiring and, more particularly, to a watertight seal assembly that is structured to prevent moisture intrusion by providing a redundant seal that does not require the use of epoxy or silicone adhesives.

2. Discussion of the Related Art

Underwater light fixtures are commonly found in residential and commercial swimming pools, as well as in marine environments and industrial settings where liquid storage is necessary. Underwater light fixtures and other submerged electric devices bear the inherit concern of an electrically conductive liquid coming into contact with the submerged electric device and/or associated electrical wiring. Consequently, several attempts have been directed towards developing a system that maintains the water-resistant integrity of an electric device housing and its associated electrical wiring. The prior art has traditionally relied upon a variety of epoxy or silicone adhesives in conjunction with a housing in order to prevent moisture intrusion.

One example is the in-ground light fixture issued to Wagner, et al. (U.S. Pat. No. 5,481,443), wherein a light fixture is housed within a fixture housing that has been radially sealed by compressing a single sealing element between the fixture housing and the fixture lens. Use of a sealing element such as an epoxy adhesive can be cumbersome, however, particularly when attempting to replace or repair the light fixture and/or the electrical wiring sealed within. Furthermore, epoxy and silicone adhesives will deteriorate and peel over time, requiring frequent replacement. Accordingly, there remains a need for a watertight seal assembly that does not employ the use of epoxy or silicone adhesives and which can maintain its watertight structural integrity by preventing moisture intrusion from damaging electrical wiring within the assembly.

### OBJECTS AND ADVANTAGES OF THE INVENTION

Considering the foregoing, it is a primary object of the present invention to provide a watertight seal assembly that provides a redundant seal for preventing moisture intrusion within the assembly.

It is a further object of the present invention to provide a watertight seal assembly that is structured for easy installation and locked attachment to the housing of an underwater electric lamp.

It is still a further object of the present invention to provide a watertight seal assembly that is adapted for easy installation and locked attachment to an electric device.

It is still a further object of the present invention to provide a watertight seal assembly that does not require the use of an epoxy or silicone adhesive to create the watertight barrier.

It is still a further object of the present invention to provide a watertight seal assembly that can be disassembled and reassembled with minimal effort.

These and other objects and advantages of the present invention are more readily apparent with reference to the detailed description.

### SUMMARY OF THE INVENTION

The present invention is directed to a watertight seal assembly for an electrical connection that prevents moisture intrusion with a submerged device and features a wire plug having an opening sized for watertight receipt of a wire jacket and apertures sized to feed wire leads into the housing of the electric device. The wire plug is sized for congruent, snug fitted receipt within a frusto-conical cavity formed by the inner wall surface of an attachment hub located on the housing of the submerged electric device. A wire cap having a hollow core sized to receive the wire jacket fits over the wire plug and locks to the housing of the submerged electric device, producing a watertight seal. The inner surface of the wire cap opening includes nubs that bite into the wire jacket as the wire cap is twisted to form the locked seal, which provides an additional barrier for avoiding moisture intrusion.

### BRIEF DESCRIPTION OF THE DRAWINGS

For a fuller understanding of the nature of the present invention, reference should be made to the following detailed description taken in conjunction with the accompanying drawings in which:

FIG. 1 is a side view of the wire plug.

FIG. 2 is a side view of the wire plug, shown in cross-section, illustrating the hollow core of the wire plug sized to receive a wire jacket and apertures sized to feed wire leads to a submerged electric device.

FIG. 3 is a top plan view of the wire plug showing the wire lead apertures.

FIG. 4 is a side view, shown in cross-section, illustrating the watertight seal assembly in conjunction with an underwater electric light fixture, according to one embodiment of the invention wherein the wire cap has been locked to an attachment hub on the housing of an underwater electric light fixture.

FIG. 5 is a bottom plan view of the wire cap, illustrating four spaced attachment prongs and opposing wing members for locking the wire cap to the attachment hub.

FIG. 6 is an isolated exploded view of the watertight seal assembly, shown in partial cross-section, taken from the area indicated as “FIG. 7” in FIG. 4 and illustrating the wire jacket fed through the wire cap and the wire plug, and the wire leads extending from the wire plug into the frusto-conical cavity and corresponding housing cavity of the electric light fixture.

FIG. 7 is an isolated view of the watertight seal assembly, shown in partial cross-section, taken from the area indicated as “FIG. 7” in FIG. 4 and illustrating the watertight seal assembly, wherein the wire cap has been locked to the housing of the underwater electric light fixture.

FIG. 8 is an isolated view of the watertight seal assembly, shown in cross-section, taken from the area indicated as “FIG. 7” in FIG. 4 and illustrating the watertight seal assembly, wherein the wire cap has been locked to the housing of the underwater electric light fixture.

FIG. 9 is a top plan view of several embodiments of the wire plug, illustrating different arrangements and configurations of the wire lead apertures.

FIG. 10 is a side view of an attachment plug ring used in a second embodiment of the watertight seal assembly.

FIG. 11 is a side view of the attachment plug ring, shown in cross-section, illustrating its threaded inner surface.

FIG. 12 is an exploded side view shown in partial cross-section illustrating the several components of the second embodiment of the watertight seal assembly being attached to the housing of an electric device.

FIG. 13 is a side view, shown in cross-section, illustrating the second embodiment of the watertight seal assembly fully assembled and secured to the housing of an electric device.

Like reference numerals refer to like parts throughout the several views of the drawings.

### DETAILED DESCRIPTION OF THE PREFERRED EMBODIMENT

Referring to the several views of the drawings, the watertight seal assembly is shown in accordance with a preferred embodiment and is generally indicated as 10.

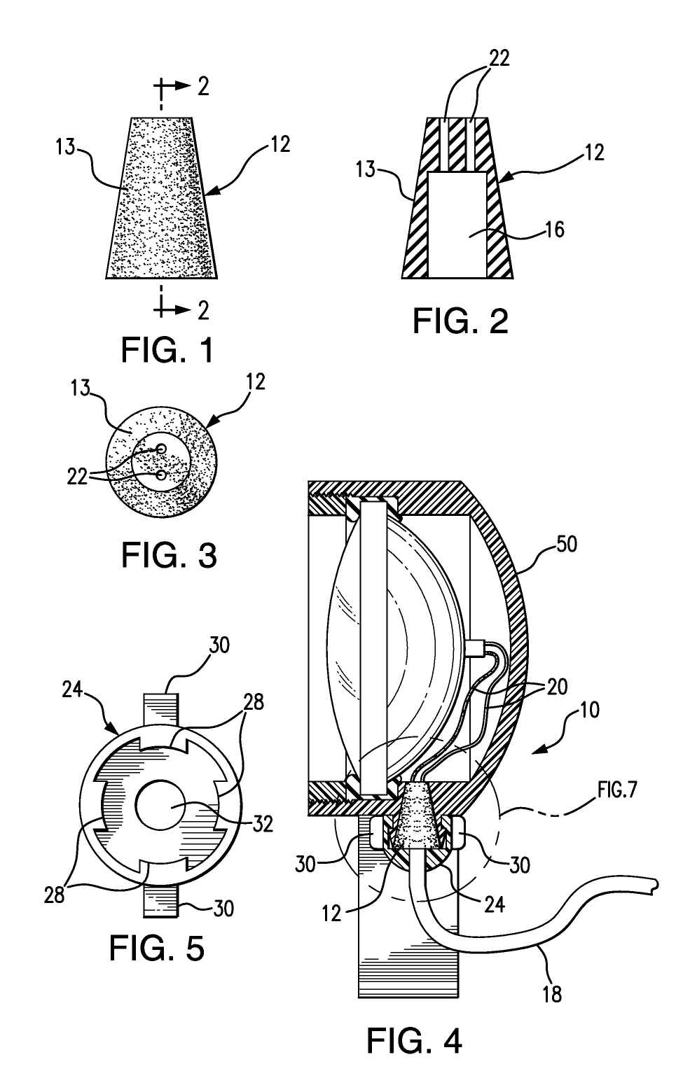

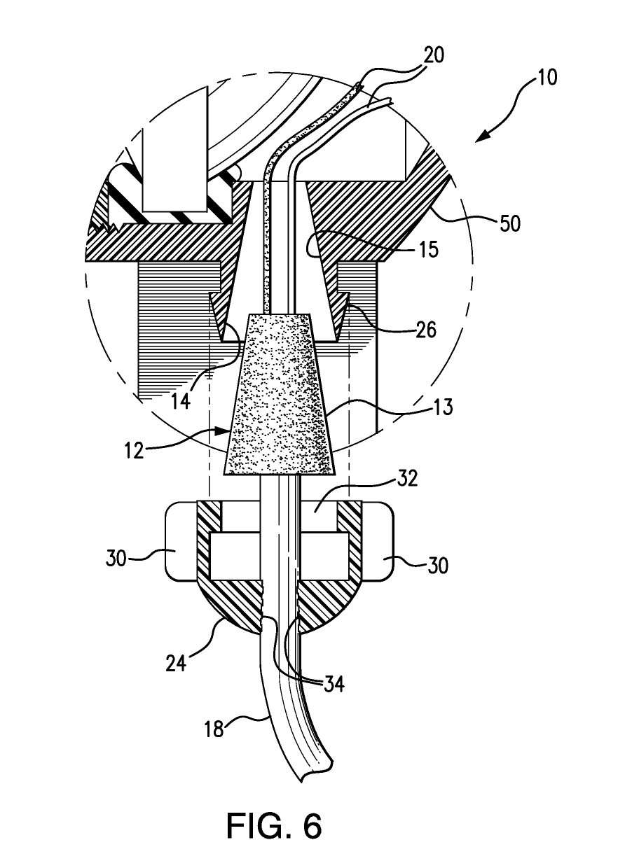

Referring initially to FIGS. 1-8, the watertight seal assembly 10 provides a watertight seal without the use of an epoxy or silicone adhesive. FIGS. 1-3 provide a detailed illustration of a wire plug 12, which is sized and configured to fit snuggly within a frusto-conical cavity 14 formed from the inner wall surface 15 of an attachment hub 26 located on the housing of an underwater electric light fixture 50 and extending through the attachment hub 26 and communicating with the exterior and interior of the housing of the light fixture 50. The wire plug 12 is composed of an elastomeric material having a frusto-conical shape with a tapered outer side surface 13 and is sized slightly larger than the frusto-conical cavity 14 in order increase the friction between the exterior surface 13 of the wire plug 12 and the interior surface 15 of the frusto-conical cavity 14, thereby preventing moisture intrusion within the frusto-conical cavity 14. An opening 16 extending within the interior of the wire plug 12 is sized to receive a waterproof wire jacket 18, which serves to encase the wire leads 20. Prior to engaging the wire plug 12 within the frusto-conical cavity 14, the wire leads 20 extending from the wire jacket 18 are fed through wire lead apertures 22 extending within the interior of the wire plug 12 and communicating with the opening 16 in the interior of the wire plug 12. The wire leads 20 are then fed into the housing of the electric lamp 50 for connection to terminals on the lamp 50.

In operation, the compressed engagement of the wire plug 12 with the inner wall surface 15 of the attachment hub 26 forms a first barrier for prevention of moisture intrusion within the watertight seal assembly 10. An additional barrier for prevention of moisture intrusion, as illustrated in FIGS. 4-8, is provided by a wire cap 24, which is sized and configured for locked attachment to the attachment hub 26 protruding from the housing of the electric lamp 50, fully surrounding the engaged wire plug 12. The wire cap 24 is structured and disposed for pressing against the wire plug 12 and compressing the wire plug 12 within the frusto-conical cavity for sealed engagement. As illustrated in FIG. 5, the wire cap 24 includes four spaced attachment prongs 28 with gaps between them to allow the wire cap 24 to be pressed onto the attachment hub 26 and rotated approximately 45 degrees to lock the wire cap 24 to the attachment hub 26. In order to facilitate locked attachment to the hub 26, the wire cap 24 includes opposing wing members 30 for easier twisting by hand. The wire cap 24 has an opening 32 which is sized and structured for watertight, sealed passage of the waterproof wire jacket 18 and wire leads 20 therethrough. A series of nubs 34 are included on the inner facing surface of the opening 32. The bubs 34 are structured to bite into the waterproof wire jacket 18 as the wire cap 24 is rotated for locked attachment to the hub 26. This biting action of the wire cap 24 into the wire jacket 18 forms a watertight seal, thereby providing a third barrier for prevention of moisture intrusion. The wire cap 24 may be unlocked and removed in order to make any necessary maintenance alterations to the watertight seal assembly 10 and/or the electric lamp 50.

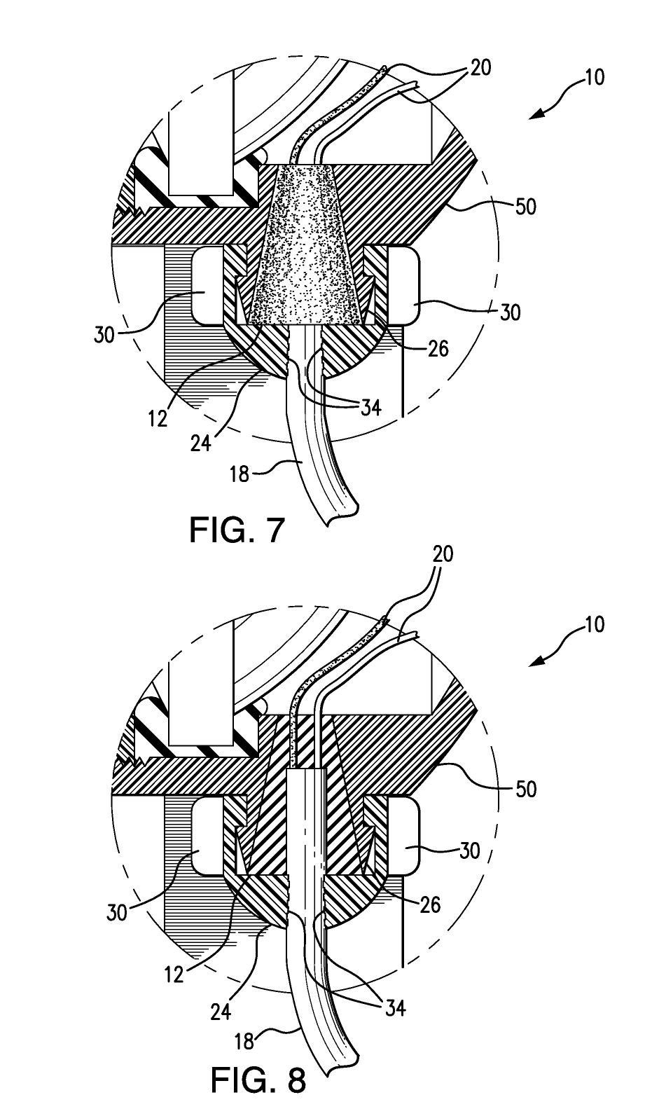

FIGS. 7 and 8 illustrate cross-sectional views of an engaged wire plug 12 and a locked wire cap 24. FIG. 7 illustrates a close-up view of an engaged wire plug 12 and a locked wire cap 24, while FIG. 8 particularly illustrates the wire leads 20 extending from the waterproof wire jacket 18 and through the wire lead apertures 22 into the fixture housing.

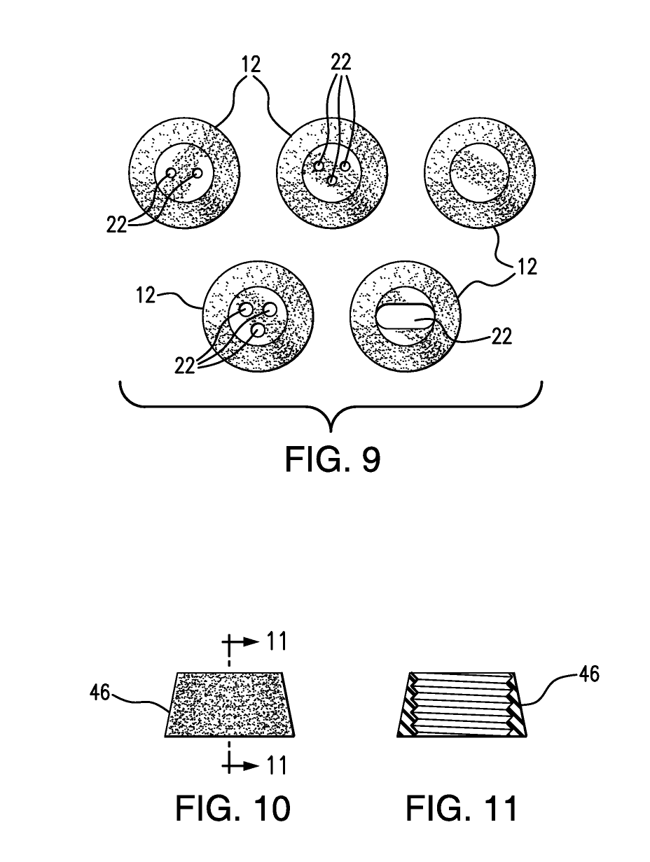

While FIGS. 1-8 have illustrated a first embodiment of the wire lead apertures 22, additional embodiments of the apertures 22 have been considered in order to accommodate various electrical conductor designs. Additional embodiments of the wire lead apertures 22 can be viewed in FIG. 9, but are not limited to those illustrated, as wire plugs 12 may be produced having wire lead apertures 22 sized for any number of different wire lead configurations.

A separate embodiment of the watertight seal assembly 10 is illustrated in FIGS. 10-12, wherein the assembly 10 is structured for use with a submerged electric device other than the electric lamp 50. In this separate embodiment, an attachment bolt member 36 having a threaded shaft component 38 is used in combination with a securing nut 40 to fasten an adapted watertight seal assembly 10 to a housing 42 of an electric device.

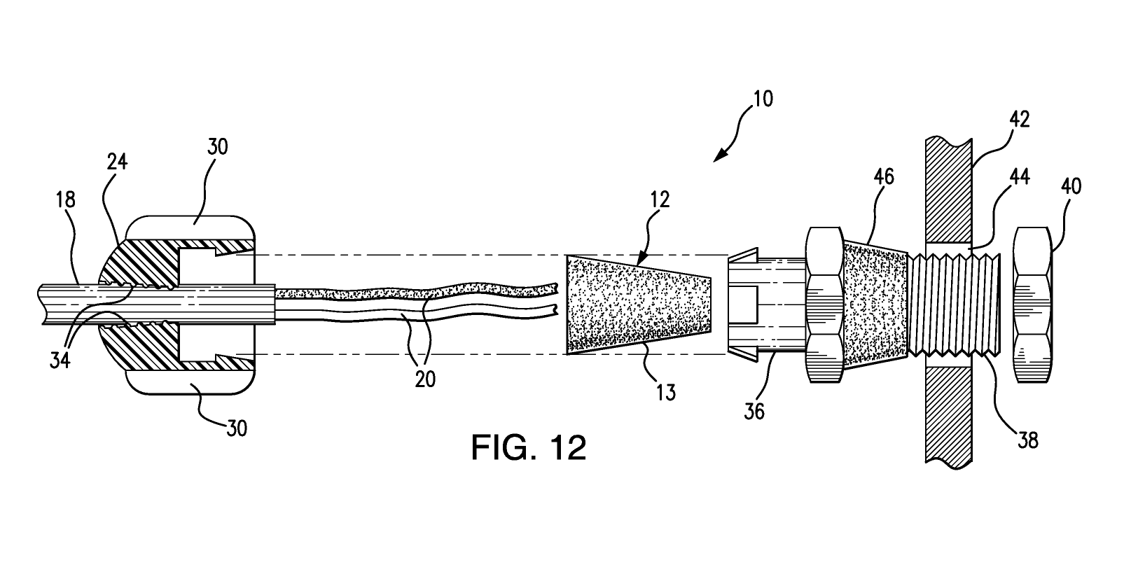

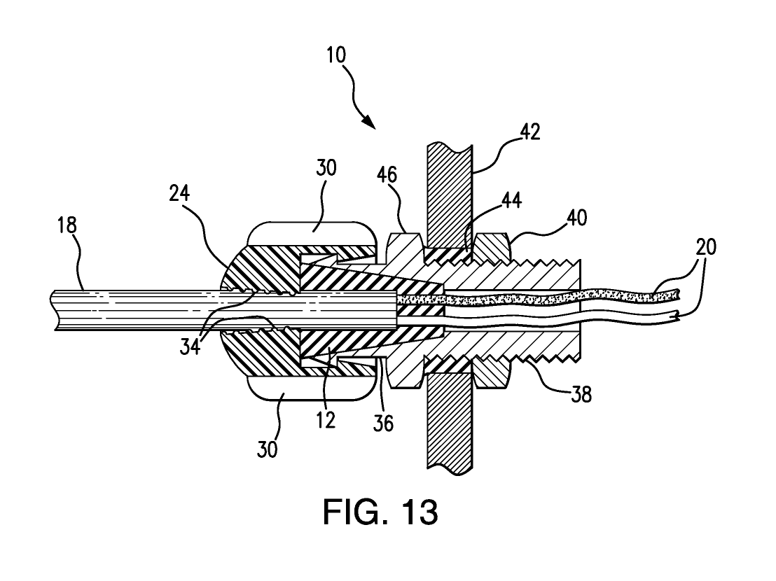

To install the adapted watertight seal assembly 10, a threaded opening 44 is drilled into the housing 42 of the electric device. Prior to engaging the threaded opening 44, an attachment plug ring 46 sized to fit snuggly within the threaded opening 44 is fitted along the threaded shaft component 38 of the attachment bolt member 36. Composed of an elastomeric material, the attachment plug ring 46 is slightly oversized to reduce moisture intrusion when compressed within the threaded opening 44. The attachment bolt member 36 engages the threaded opening 44 from the outer surface of the housing 42. The securing nut 40 is then fitted to the attachment bolt member 36 from the inner surface of the housing 42. The combined assembly of the attachment bolt member 36 and the securing nut 40 can then be tightened, securing the combination to the housing 42 and compressing the attachment plug ring 46 within the threaded opening 44. While the securing nut 40 illustrated in FIGS. 12-13 is a hex-type nut, any appropriately configured and sized securing nut may be used.

The attachment bolt member 36 includes an attachment hub 26 having an inner wall surface 15 surrounding a frusto-conical cavity 14 that is structurally identical to the feature of the same name described above in the first embodiment. After the attachment bolt member 36 has been secured to the housing 42, the wire plug 12 is received within the frusto-conical cavity 14. Subsequently, the wire cap 24 is pressed onto the attachment hub 26 and twisted approximately 45 degrees for locked attachment. This causes the wire plug 12 to be compressed which presses the outer surface 13 of the wire plug 12 into sealed engagement with the inner wall surface of the attachment hub cavity 14. After the wire cap 24 has been locked to the attachment hub 26, the wire cap 24 may be unlocked and removed in order to make any necessary maintenance alterations to the watertight seal assembly 10 and/or the submerged electric device.

While the present invention has been shown and described in accordance with several preferred and practical embodiments thereof, it is recognized that departures from the instant disclosure are fully contemplated within the spirit and scope of the present invention which is not limited except as defined in the following claims as interpreted under the Doctrine of Equivalents.

What is claimed is:

1. A watertight seal assembly on a housing of an electrical device for watertight connection of electrical conductors incased within a jacket to the electrical device, said watertight seal assembly comprising:
an attachment hub with a frusto-conical shaped inner wall surface surrounding a cavity extending through said attachment hub and communicating between an exterior and an interior of said housing;
a wire plug having a frusto-conical shape with a tapered outer side surface extending between a first end and an opposite second end, said wire plug being sized and configured for congruent, snug fitted receipt within said frusto-conical cavity;
said wire plug including an opening on said first end and extending within an interior of said wire plug, said opening being sized for insertion and passage of said jacket and electrical conductors therethrough, and said wire plug further including a plurality of wire lead apertures on said opposite second end and extending within said interior of said wire plug and communicating with said opening, said plurality of wire lead apertures being sized for passage of said electrical conductors therethrough and directing said electrical conductors into the housing of said electrical device;
a wire cap structured and disposed for removable locked attachment to said attachment hub, and said wire cap being further structured and disposed for pressing against said first end of said wire plug and compressing said wire plug within said frusto-conical cavity to cause said outer side surface of said wire plug to be pressed into sealed engagement with said inner wall surface of said attachment hub; and
said wire cap having an opening extending therethrough for watertight, sealed passage of said jacket and electrical conductors therethrough.

2. The watertight seal assembly as recited in claim 1, wherein the electrical device is an underwater light.

3. The watertight seal assembly as recited in claim 1, wherein said attachment hub is integrally formed with said housing of the electrical device.

4. The watertight seal assembly as recited in claim 1, wherein said wire plug is composed of an elastomeric material.

5. The watertight seal assembly as recited in claim 1, wherein said wire cap further comprises a plurality of wing members structured and disposed for gripping by a user's hand for locking said wire cap to said attachment hub.

6. The watertight seal assembly as recited in claim 1, wherein said opening of said wire cap is structured and disposed for biting into the wire jacket to form a watertight seal.

7. A watertight seal assembly for installation on a housing of an electrical device, said watertight seal assembly being structured and disposed for watertight connection of electrical conductors incased within a jacket to the electrical device, and said watertight seal assembly comprising:
an attachment bolt member having a first end and an opposite second end, said attachment bolt member comprising:
an attachment hub on the first end with a frusto-conical shaped inner wall surface surrounding a cavity extending through said attachment hub and communicating with an opening on the second end of said attachment bolt member; and
a threaded shaft component on the second end of said attachment bolt member, said threaded shaft component be sized for insertion within a drilled opening on an outer facing side of said housing;
an attachment plug ring sized and configured for insertion onto said threaded shaft component, and said attachment plug ring being further sized and configured for congruent, snug fitted insertion within said frusto-conical cavity;
a securing nut sized and configured for threaded insertion onto said threaded shaft component, and said securing nut being structured and disposed for securing said attachment bolt member to said housing by pressing against an inner facing side of said housing;
a wire plug having a frusto-conical shape with a tapered outer side surface extending between a first end and an opposite second end, said wire plug being sized and configured for congruent, snug fitted receipt within said frusto-conical cavity;
said wire plug including an opening on said first end and extending within an interior of said wire plug, said opening being sized for insertion of said jacket and electrical conductors therethrough, and said wire plug further including a plurality of wire lead apertures on said opposite second end and extending within said interior of said wire plug and communicating with said opening, said plurality of wire lead apertures being sized for passage of said electrical conductors therethrough and directing said electrical conductors into the housing of said electrical device;
a wire cap structured and disposed for removable locked attachment to said attachment hub, and said wire cap being further structured and disposed for pressing against said first end of said wire plug and compressing said wire plug within said frusto-conical cavity to cause said outer side surface of said wire plug to be pressed into sealed engagement with said inner wall surface of said attachment hub; and
said wire cap having an opening extending therethrough for watertight, sealed passage of said jacket and electrical conductors therethrough.

8. The watertight seal assembly as recited in claim 7, wherein the electrical device is an underwater light.

9. The watertight seal assembly as recited in claim 7, wherein said attachment plug ring is composed of an elastomeric material.

10. The watertight seal assembly as recited in claim 7, wherein said wire plug is composed of an elastomeric material.

11. The watertight seal assembly as recited in claim 7, wherein said wire cap further comprises a plurality of wing members structured and disposed for gripping by a user's hand for locking said wire cap to said attachment hub.

12. The watertight seal assembly as recited in claim 7, wherein said opening of said wire cap is structured and disposed for biting into the jacket to form a watertight seal.

13. A watertight seal assembly on a housing of an underwater electrical light for watertight connection of electrical conductors incased within a jacket to the electrical device, said watertight seal assembly comprising:
an attachment hub with a frusto-conical shaped inner wall surface surrounding a cavity extending through said attachment hub and communicating between an exterior and an interior of said housing;
an elastomeric wire plug having a frusto-conical shape with a tapered outer side surface extending between a first end and an opposite second end, said elastomeric wire plug being sized and configured for congruent, snug fitted receipt within said frusto-conical cavity;
said elastomeric wire plug including an opening on said first end and extending within an interior of said elastomeric wire plug, said opening being sized for insertion and passage of said jacket and electrical conductors therethrough, and said elastomeric wire plug further including a plurality of wire lead apertures on said opposite second end and extending within said interior of said elastomeric wire plug and communicating with said opening, said plurality of wire lead apertures being sized for passage of said electrical conductors therethrough and directing said electrical conductors into the housing of said underwater electric lamp;
a wire cap structured and disposed for removable locked attachment to said attachment hub, and said wire cap being further structured and disposed for pressing against said first end of said elastomeric wire plug and compressing said elastomeric wire plug within said frusto-conical cavity to cause said outer side surface of said elastomeric wire plug to be pressed into sealed engagement with said inner wall surface of said attachment hub;
said wire cap having an interior surface surrounding an opening extending therethrough, and said interior surface being structured and disposed for biting into the jacket to form a watertight, sealed passage of said jacket and electrical conductors therethrough; and
a plurality of wing members on said wire cap, said plurality of wing members being structured and disposed for gripping by a user's hand for locking said wire cap to said attachment hub.
